(19) United States
(12) Patent Application Publication
(10) Pub. No.: US 2017/0178166 A1
(43) Pub. Date: Jun. 22, 2017

(54) METHOD AND SYSTEM FOR OBTAINING GEOGRAPHIC CHARACTERIZATION DATA

(71) Applicant: MASTERCARD INTERNATIONAL INCORPORATED, Purchase, NY (US)

(72) Inventors: Avyaktanand Tiwary, Gurgaon (IN); Suneel Bhatt, Delhi (IN); Sanket Nerkar, Gurgaon (IN); Sharan Bakshiram, Shahjahanpur (IN)

(21) Appl. No.: 15/382,916

(22) Filed: Dec. 19, 2016

(30) Foreign Application Priority Data
Dec. 18, 2015 (SG) 10201510446R

(51) Int. Cl. G06Q 30/02; G06Q 50/12

(52) U.S. Cl. CPC G06Q 30/0205; G06Q 50/12

(57) ABSTRACT

Payment transaction data for consumers who make purchases in a geographical region is used, together with information about restaurants the consumers have made payments to, to obtain statistical data characterizing the restaurant habits of the consumers. This information may be useful for designing marketing operations, or to individuals contemplating opening a restaurant in the region.

### FIELD OF THE INVENTION

The present invention relates to computer systems and computer-implemented methods for obtaining data characterizing purchasing habits of consumers in a geographical location.

### BACKGROUND OF THE INVENTION

Several automated methods exist for obtaining information about the purchasing habits of individual consumers, based on their spending behavior. This can be used for targeting product advertising to the individual consumers based on their previous purchases. Additionally, it can be used to identify market trends, such as that there is increasing market demand for a certain product. The term “product” is used in this document to include both objects (i.e. physical products), data products and services.

### SUMMARY OF THE INVENTION

The present invention aims to provide new and useful computer systems and computer implemented inventions for obtaining information about purchasing behavior.

In general terms, the present invention proposes defining at least one geographical region, and using payment transaction data for consumers who make purchases in that region, and information about competing merchants who offer products in the region, to obtain statistical data characterizing payment habits of the consumers in the region (“geographical region characterization data”).

Thus, in contrast to conventional automated mechanisms for gathering information about the purchasing behavior of consumers, which as noted above tends to obtain information about individual consumers, or about a market as a whole, the present invention makes it possible to obtain information characterizing a geographical region.

This information may be useful in several ways. Firstly, it can be used by existing merchants in the geographical region to plan commercial activities to obtain more customers, such as by offering products in a new commercial range, or by sending out targeted advertising in the geographical region.

It would further permit potential merchants who may be considering obtaining an outlet in the geographical region to obtain information about the consumers of the region, to enable them to make a decision about whether to open an outlet in the geographical region, and if so, how to tailor it to the consumption preferences of the consumers. For example, a merchant who already operates, or is considering operating, one or more outlets fitting one or more of the categories, may scan corresponding geographical region characterization data for each of a plurality of regions, to find one which matches the properties of the outlets of the merchant.

In a preferred form of the invention the merchants are business establishments where meals or refreshments may be purchased. Such merchants are here referred to as “restaurants”. Typically, but not always, the restaurants provide facilities on which the food may be consumed (i.e. they are eat-in restaurants, rather than take-away restaurants). The meals or refreshments are typically pre-cooked (a term which is used to include pre-baked), and are typically served warm, although invention is applicable also to restaurants (such as juice bars and certain vegetarian restaurants) where the meals or refreshments are not pre-cooked or served warm.

A specific expression of the invention is a computer-implemented method for obtaining geographic region characterization data statistically characterizing the consumption habits of consumers in a geographical region, the method including:
(i) identifying a plurality of consumers associated with the region,
(ii) obtaining, for each of a plurality of merchants who perform sales in the region, the merchants being competitors in a commercial sector, corresponding merchant characterization data which indicates whether the commercial activity of the merchant belongs to one of more of a set of merchant categories, and
(iii) using payment transaction data for the identified consumers, and the merchant characterization data, to obtain respective geographical region characterization data describing statistically the purchasing behavior of the identified consumers in relation to the merchant categories.

As noted above, in a preferred form of the invention the merchants are restaurants. In this case, the merchant categories include (a) categories associated with respective types of cuisine (e.g. a national cuisine such as “Italian”, “Indian”, or “French”; or a cuisine defined based on ingredients, such as “vegetarian” or “vegan”; note that a certain restaurant may belong to multiple ones of these categories, e.g. if it sells Indian vegetarian food), (b) categories indicative of price (e.g. “high price” “economy”), and/or (c) categories associated with type of premises (e.g. diner, café, pub, take-away, exclusive restaurant).

The method may include a step of ranking the merchants based on the payment transaction data, thereby identifying popular merchants. The step of obtaining the geographical region characterization data (i.e. step (iii) in the list of steps given above) may then exclude merchants who are below a threshold in the popularity ranking.

The payment transaction data ranking may be based on a function of any one or more of the total money spent at the merchant (e.g. during a predetermined period), the number of payment transactions (e.g. in the predetermined period), and/or the average amount spent per transaction.

The step of obtaining the geographical region characterization data may include a clustering step, whereby the geographical region characterization data comprises data indicating one of more “clusters” of consumers, that is sets of consumers whose spending behavior meets at least one similarity criterion. The set of consumers may have a cardinality (i.e. the number of consumers in the set) which is above a threshold. The threshold may be chosen to be sufficiently high, and/or the at least one similarity criterion may be chosen to be sufficiently strict, that the cluster is of statistical significance. That is, the probability that it arose purely by chance as an artefact of the payment transaction data, without reflecting a true clustering of consumer behavior, is below a likelihood threshold, e.g. less than 5%.

The step of obtaining the geographical region characterization data may employ demographic information describing the identified consumers, so that the geographical region characterization information is indicative of the purchasing behavior in relation to the categories of those of the identified consumers who are in at least one demographic category.

The demographic data may be used in the clustering procedure (if any). That is, at least one of the similarity criteria may be indicative of demographic similarity. In this way, clusters of the data may be associated with respective demographic groups.

The merchant characterization data may include information obtained automatically from a consumer data website, such as social media website.

The payment transaction data refers to a payment made using a payment card. As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, transponder devices, NFC-enabled devices, and/or computers.

The invention may be expressed in terms of a method performed by a computer-system automatically, or as a computer-system arranged to perform the method. The term “automatic” is used here to mean substantially without human involvement except with regard to initiation of the method, such as by defining the categories which are used in step (iii).

### BRIEF DESCRIPTION OF THE FIGURES

An embodiment of the invention will now be described for the sake of example only with reference to the following drawings, in which:

FIG. 1 shows a computerized network including a server or performing a method which is an embodiment of the invention;

FIG. 2 is a flowchart of the method which is an embodiment of the invention;

FIG. 3 is a representation of data obtained using the method of FIG. 2; and

FIG. 4 shows schematically the technical architecture of a server for performing the method of FIG. 2.

### DETAILED DESCRIPTION OF THE EMBODIMENTS

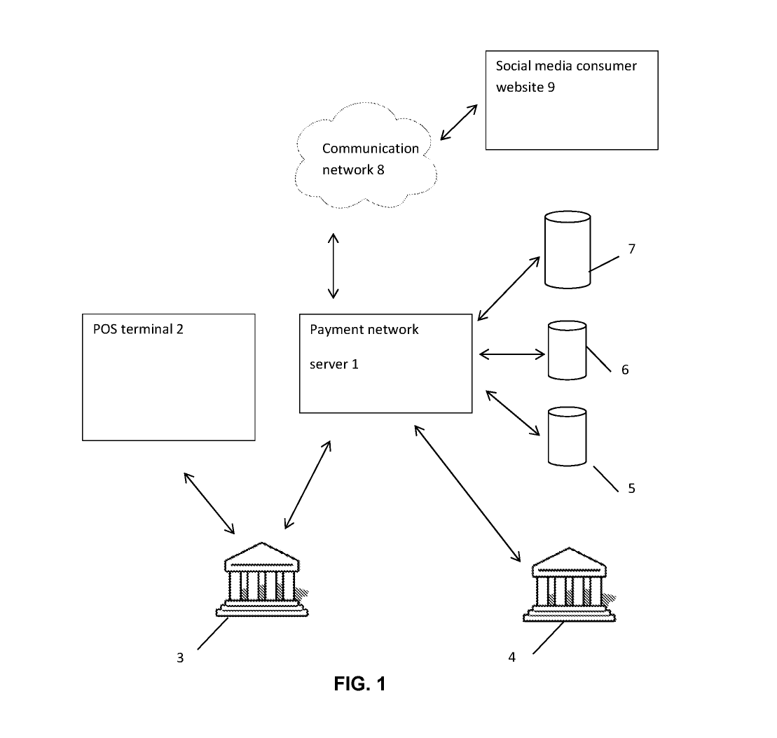

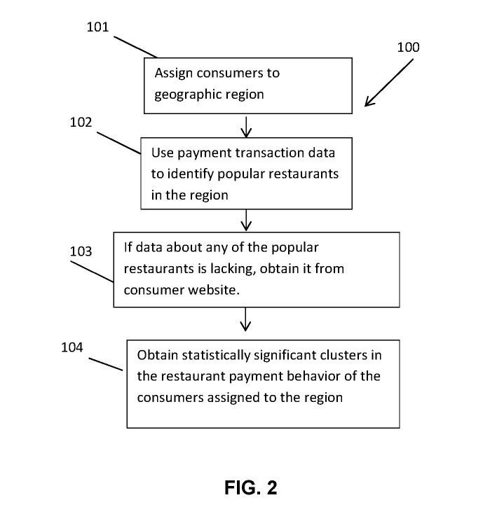

Referring firstly to FIG. 1, a computerized network is shown including a server 1 which can perform a method which is an embodiment of the invention. The method is explained below with reference to FIG. 2. The server 1 is associated with a payment network for processing payment transactions made using payment cards issued by corresponding issuer banks. These include payment transactions involving restaurants.

The computerized network is capable of performing a known payment process which is as follows. Typically, a consumer who holds a payment card issued by an issuer bank makes a payment by presenting his or her payment card to a POS terminal 2 operated by a merchant. For simplicity only one POS terminal is included in FIG. 1, but in actuality the computerized network typically contains thousands of POS terminals, operated by corresponding merchants. The POS terminal 2 sends a message to a server 3 of an acquirer bank, where the merchant maintains an account, including the details of the payment card (possibly in encrypted form) and the amount of the payment. The acquirer bank server 3 sends a message to the payment network server 1, again including the details of the payment card and the amount of the payment. The payment server 1 determines the issuer bank which issued the payment card, and sends an authorization request to an issuer bank server 4 operated by the issuer bank. For simplicity only a single issuing bank server 4 is illustrated in FIG. 1, although in actually there will be many such servers associated with respective issuing banks. The issuer bank server 4 either authorizes the transaction, or declines it, and in any case sends a corresponding message to the payment network server 1, which passes the message to the acquirer bank server 3, which forwards it to the POS terminal 2. If the decision of the issuer bank server 4 was to authorize the transaction, then the acquirer bank credits the payment amount (possibly less a handling charge) to the account of the merchant, and the issuer bank 4 debits it from an account associated with the payment card. At a later time (typically during a clearing operation) the issuer bank 4 makes a payment to the acquirer bank. The payment network server 1 retains details of the payment transaction in a database 5.

Unlike a conventional payment network server, the payment network server 1 is able to access a further merchant database 6 containing data for each of a plurality of merchants, and a consumer database 7 containing data for each of a plurality of consumers (all of whom carry one or more corresponding payment cards). In the following description it is assumed that the merchants each operate one or more restaurants (typically of the kind in which food is consumed on the premises, but possibly also take-away restaurants), but in variations of the embodiment the merchants could be active in another commercial sector in which they are competitors.

The data in the merchant database 6 includes details of the payment accounts associated with the corresponding merchants. The database 6 further includes a geographical location of each restaurant. The merchant database 6 further includes merchant characterization data indicating, for each of the merchants, which of a number of categories the restaurant falls into: (i) a plurality of categories based on the type of cuisine sold by the restaurant (e.g. there may be respective categories for each of a number of national cuisines such as “Chinese”, “Italian”, “Pub food” or “Indian food”; there may also be categories based on ingredients, such as “vegetarian” or “non-vegetarian” or “vegan”; a given restaurant will typically be in multiple categories), (ii) a plurality of categories corresponding to respective price ranges for the restaurant (e.g. “budget”, or “high price”, and (iii) a plurality of categories corresponding to respective restaurant types (e.g. a diner, café, take-away, pub, family restaurant, or an exclusive (“elegant”) restaurant).

The data in the merchant database 6 may optionally be obtained from an external source (e.g. an existing database of restaurants, such as one maintained by a restaurant chain), or it may be generated by a carrying out a survey for restaurants in certain geographic regions(s). Another possibility however is that the payment network server 1 uses a communication network 8 such as the internet to obtain the information from at least one consumer website 9, which may be a social media consumer website such as Yelp, Zagat, Zomato etc which aggregates information submitted by multiple consumers.

The consumer database 7 contains a residence address associated with each of the consumers. The residence address is typically obtained from the issuer bank of the payment card. The consumer database 7 further contains demographic data characterizing the payment card holders. This may include an age range of the payment card holder, his/her gender, his/her marital status (and any more information which may be available about his/her family circumstances), and financial information relating to the payment card holder such as his/her salary or data characterizing his/her payment behavior using the payment card (e.g. average monthly spend using the payment card). Payment transactions by payment card holders for whom demographic information is missing from the consumer database 7 may optionally not be used in the method of FIG. 2.

Turning to FIG. 2, a flow chart is shown which shows the steps of a method 100 which is an embodiment of the invention. The invention may be performed by the server 1, or indeed by any other computer system which has access to the data in the databases 5, 6, 7. The method is carried out in respect of at least one specified geographic region (e.g. a certain town, a certain postcode/zipcode or range of postcodes/zipcodes, or regions defined for use in the method). Optionally, the database 6 may only contain data in respect of restaurants for whom the geographical location is in the at least one specified geographical region. If data in respect of restaurants is present, that data is not used in the method 100.

Each of the geographic region(s) has a size which is in accordance with a typical distance which consumers are prepared to travel to a restaurant. For example, its extent (i.e. which may be defined as the length of the longest straight line which can be drawn entirely within the geographic region) may be at least 50 m, or at least 100 m, and/or at most 10 km, at most 5 km, or at most 2 km. Note that the sizes of the geographical region(s) may differ from each other, e.g. so as to be larger in rural areas.

The geographical region(s) may be selected in a pre-step of the method (not shown in FIG. 2). The size(s) of the geographical region(s) might be different for certain categories of restaurant. For example, they might be chosen to be small for a fast-food restaurant and larger for a high-end restaurant.

In step 101, the server 1 attempts to assign the consumers for whom payment transaction data exists in the database 5 to one of the specified geographic regions (e.g.zip code areas). Consumers who are not assigned to any of the specified geographic regions are not considered further in the method 100, and the data about them and their transactions is not used in the method.

The assignment of consumers to the specified geographic regions may be done simply by checking whether the consumers' residential addresses are within one of the specified geographical regions.

Alternatively, and more preferably, step 101 uses a code model in which a consumer is assigned to a geographical region based both on the residential address and on the locations at which the consumer spends money according to the payment transaction data in the database 5. This would avoid the risk of a consumer being assigned to a geographical location where he or she happens to live but where he or she makes almost no purchases (e.g. because it is rural, and because he or she spends almost all their money in a neighboring town).

For example, a consumer may be allocated to a specified geographical region if at least a certain proportion of all the spending which the consumer performs within a certain radius of the residential address, is within the geographical region.

Note that unlike an assignment process which is based entirely upon the locations of merchants at which the payment card is used (i.e. one which does not use the consumer's residential address at all), an assignment process based both on the residential address and on the payment transactions in a locality of the residential address, reduces the risk of a consumer being assigned to a geographical region where he or she rarely goes but which contains an organization at which he or she makes major purchases (e.g. remotely). In other words, it increases the chance that the consumer will be assigned to a particular geographical region based on everyday spending, rather than large exceptional spending.

Another way of doing this would be to assign a consumer to a geographical regions by recognizing geographical clustering in the locations at which the consumer makes payments according to the payment transaction data.

A further possibility would be for the server 1 to perform step 101 using (at least partly) data associated with the payment card. For example, many payment cards are associated with a permanent account number (PAN). In some cases the PAN links the payment card to a bank associated with a certain geographical region. For example, a payment card from a German bank is typically associated with a German card holder. If such a payment card is used in another geographical region (e.g. a geographical region in the US), the server 1 may identify the card holder as a temporary visitor in the geographical region. Optionally, the server 1 may exclude transaction data from that payment card in the following process.

The possible implementations of step 101 discussed above identify consumers who are resident in or near the geographical location as well as having spent money there. An alternative would be to identify consumers associated with the geographical region as consumers who have made purchases in (or near) a geographical region but who are not resident there. One way of doing this would be for step 101 to exclude from the identified consumers any consumer whose residence address is within the geographical region (and optionally also consumers whose residence address is within a certain distance from the geographical region). Alternatively, if step 101 is performed using the PAN number of the payment card (as mentioned above), the server 1 may identify the consumers as ones who have made a purchase in the geographical region but whose PAN number is associated with an issuing bank which is distant from the geographical region (e.g. in another country).

The set of steps 102-104 are performed separately for each of the specified geographical regions, using only the data in the databases 5, 6, 7 relating to the consumers assigned to the specified geographical region, and the restaurants located there.

In step 102, for all the consumers assigned to a given specified geographical region, the payment transactions of the consumers to the restaurants in that region are used to derive a popularity index for each of the restaurants. This may be defined as a function of any one or more of total spend, total number of transactions or ticket size (i.e. average spend per transaction). The restaurants are then ranked based on the popularity index.

In optional step 103, it is determined whether for any of the restaurants high in the ranking (e.g. with a popularity index above a threshold), the database 6 is lacking merchant characterization data. If so, it is supplemented by drawing information from the consumer website(s) 9 over the communication network 8.

In step 104, using the popularity index and the merchant characterization data, as well optionally as demographic data from the database 7, a clustering algorithm is used to obtain statistical information about the restaurant spending habits of consumers in the geographic region. The statistical information is not consumer-specific; but represents statistically significant numerical values characterizing the restaurant spending behavior of typical consumers who make purchases in, and live in (or near to), the geographical location. Alternatively, if, as mentioned above, the consumers identified in step 101 as being associated with the geographical region, are ones who have made purchases there, but who are not resident there (or near there), then the statistical information will characterize the restaurant spending behavior of visitors to the geographical location.

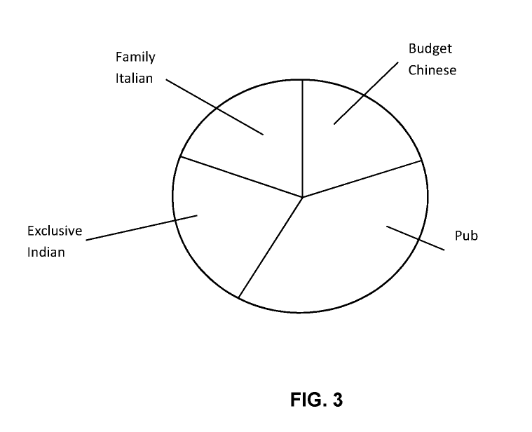

A typical result is shown in FIG. 3, showing that in respect of a certain geographical region, four statistically significant clusters of restaurant spending have been identified: budget Chinese, family Italian restaurants, exclusive Indian restaurants, and pub spending. This is presented as a pie diagram, in which each of the clusters is represented by a respective segment of a circle, which subtends a respective angle at the center of the circle which represents its respective statistical significance. Any of these clusters may, for example, be indicative of the number of restaurants of the corresponding type in the region being high, and/or the total number of payment transactions at restaurants of that type in the region being high, and/or the total spend at restaurants of that type in the region being high. The user of the method may, if desired, tailor the clustering algorithm to seek clusters of one or more of these types, according to the information in which he/she is most interested. Note that the diagram is not cluttered with very thin segments, because such a segment would represent a cluster with low statistical significance, and such a cluster would not be identified at all in step 104.

It can be seen that the most statistically significant cluster for this region is for exclusive Indian cuisine. This information may be used by someone considering opening such a restaurant in the geographical region.

Step 104 may be repeated excluding certain types of restaurants, to obtain more detail about the others. For example, typically, the payment transactions will include spending both on food and drink at the restaurants. For certain restaurants (e.g. the pubs) the spending on drink will be a high proportion of spending, so a certain user of the method may exclude the data in respect of pubs.

Similarly, an operator of restaurants catering to a certain demographic, e.g. single young people, may instruct the server 1 to perform (or repeat) the method of FIG. 2 using, in step 104, only payment transaction data relating to consumers who, according to the database 7, are in that demographic, to obtain data which shows the restaurant spending behaviour of that demographic.

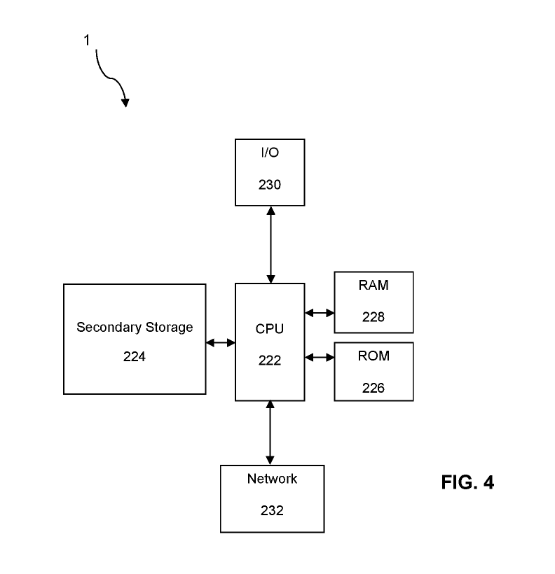

FIG. 4 is a block diagram showing a technical architecture of the payment network server 1.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 comprises non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A computer-implemented method for obtaining geographic region characterization data statistically characterizing the consumption habits of consumers in a geographical region, the method including a computer server:
(i) identifying a plurality of consumers associated with the region,
(ii) obtaining, for each of a plurality of merchants who perform sales in the region, the merchants being competitors in a commercial sector, corresponding merchant characterization data which indicates whether the commercial activity of the merchant belongs to one of more of a set of merchant categories, and
(iii) using payment transaction data for the identified consumers, and the merchant characterization data, to obtain respective geographical region characterization data describing statistically the purchasing behavior of the identified consumers in relation to the merchant categories.

2. A method according to claim 1 in which the merchants operate restaurants and the merchant characterization data characterizes the corresponding restaurants.

3. A method according to claim 2 in which the merchant categories include one or more of (a) a plurality of categories associated with respective types of cuisine, (b) a plurality of categories indicative of price, and/or (c) a plurality of categories associated with type of restaurant premises.

4. A method according to claim 1 which includes a step of ranking the merchants based on the payment transaction data for the identified consumers.

5. A method according to claim 4 in which the ranking is based on a popularity index which is a function of any one or more of the total money spent at the merchant, the number of payment transactions to the restaurant, and/or the average amount spent per transaction.

6. A method according to claim 1 in which the step of obtaining the geographical region characterization data includes a clustering step, to identify one of more sets of consumers who meet at least one similarity criterion in relation to their spending behavior.

7. A method according to claim 1 in which the step of obtaining the geographical region characterization data employs demographic information describing the identified consumers, whereby the geographical region characterization information is indicative the purchasing behavior in relation to the merchant categories of those of the identified consumers who are in at least one demographic category.

8. A method according to claim 1 in which at least part of the merchant characterization data used in the step of obtaining the geographical region characterization data is obtained from a consumer data website.

9. A method according to claim 8 in which the step of obtaining the geographical region characterization data includes identifying in a database of said merchant characterization data, at least one of the merchants for whom the merchant characterization data in the database does not meet a completeness criterion, and for the identified at least one merchant obtaining further merchant characterization data from the consumer data website.

10. A method according to claim 1 in which said step of identifying the plurality of consumers associated with the region is performed using both a residential address for each consumer and payment transaction data for the consumer.

11. A method according to claim 1 in which the step of identifying the plurality of consumers associated with the region identifies consumers who have made purchases in the region and whose residence is in the region.

12. A method according to claim 1 in which the step of identifying the plurality of consumers associated with the region identifies consumers who have made purchases in the region and whose residence is not in the region.

13. A computer system for obtaining geographic region characterization data statistically characterizing the consumption habits of consumers in a geographical region, the computer system comprising a processor and a data storage device storing:
(a) program instructions,
(b) a payment transaction database comprising payment transaction data describing payment transactions made by consumers;
(c) a consumer database of data describing the consumers; and
(d) a merchant database storing merchant characterization data in respect of each of plurality of merchants, the merchant characterization data being indicative of whether the commercial activity of the merchant belongs to one of more of a set of merchant categories;
the program instructions being operative, upon being performed by the processor to cause the processor:
(i) using the consumer database to identify a plurality of consumers associated with the region,
(ii) to extract from the merchant database merchant characterization data in respect of a plurality of the merchants which operate commercially in the region, and
(iii) to use the payment transaction data for the identified consumers, and the extracted merchant characterization data, to obtain respective geographical region characterization data describing statistically the purchasing behavior of the identified consumers in relation to the merchant categories.

14. A computer system according to claim 13 in which the program instructions are operative to cause the processor to rank the merchants which operate commercially in the region based on payment transaction data for the identified consumers.

15. A computer system according to claim 14 in which the ranking is based on a popularity index which is a function of any one or more of the total money spent at the merchant, the number of payment transactions to the restaurant, and/or the average amount spent per transaction.

16. A computer system according to claim 13 in which the program instructions are operative to cause the processor perform a clustering step, to identify one of more sets of consumers who meet at least one similarity criterion in relation to their spending behavior.

17. A computer system according to claim 13 in which the consumer database comprises demographic information describing the consumers, whereby the geographical region characterization information is indicative the purchasing behavior in relation to the categories of those of the identified consumers who are in at least one demographic category.

18. A computer system according to claim 13 in which the program instructions are operative to cause the processor to obtain at least part of the merchant characterization data over a communication network from a consumer data website.

19. A computer system according to claim 18 in which the program instructions are operative to cause the processor to identify in the merchant database merchant at least one of the merchants for whom the merchant characterization data in the database does not meet a completeness criterion, and for the identified at least one merchant obtain further merchant characterization data from the consumer data website.

20. A computer system according to claim 13 in which the program instructions are operative to cause the processor identify the plurality of consumers associated with the region using both a residential address for each consumer stored in the consumer database, and payment transaction data stored in the payment transaction database.

21. A computer system according to claim 13 in which the program instructions are operative to cause the processor to identify the plurality of consumers associated with the region as consumers who have made purchases in the region and who meet a criterion indicative of the consumer residing in the region.

22. A computer system according to claim 13 in which the program instructions are operative to cause the processor to identify the plurality of consumers associated with the region as consumers who have made purchases in the region and who meet a criterion indicative of the consumer not residing in the region.
